(19) United States
(12) Patent Application Publication
(10) Pub. No.: US 2017/0231467 A1
(43) Pub. Date: Aug. 17, 2017

(54) STORAGE AND CLEANING DEVICES, SYSTEMS, AND METHODS, SUCH AS FOR JEWELRY

(71) Applicant: Arden Paglia, Mercer Island, WA (US)

(72) Inventor: Arden Paglia, Mercer Island, WA (US)

(21) Appl. No.: 15/431,260

(22) Filed: Feb. 13, 2017

Related U.S. Application Data
(60) Provisional application No. 62/294,707, filed on Feb. 12, 2016.

(51) Int. Cl. A47L 25/00; B65D 25/04; B05B 11/00; B65D 41/02; B65D 25/20; B65D 43/22; B08B 3/02; B65D 43/02

(52) U.S. Cl. CPC A47L 25/00; B08B 3/026; B65D 25/04; B65D 43/02; B65D 41/02; B65D 25/205; B65D 43/22; B05B 11/30

(57) ABSTRACT

A storage and cleaning device in accordance with this disclosure is a multi-compartment. case for cleaning and storing one or more items, such as earrings. One end of the device can contain antibiotic cream for dispensing to protect and soothe a person's piercings. The other end of the device can hold a choice of treatment fluid for cleaning purposes, such as to clean ears or earrings. The center of the device can comprise a flip top lid or otherwise accessible compartment to securely hold one or more suitable items, such as jewelry items, and particularly earrings for example. Users can customize the look of the case with one or more optional sticker sheets.

### CROSS-REFERENCE TO RELATED APPLICATIONS

This application claims benefit of U.S. Provisional Patent Application Ser. No. 62/294,707, filed Feb. 12, 2016, herein incorporated by reference in its entirety.

### TECHNICAL FIELD

The present disclosure pertains to methods, systems, and devices for storing small objects, in particular jewelry.

### BACKGROUND

People across the world wear various types of jewelry. Often, it is desirable and advantageous to remove jewelry items temporarily, such as and without limitation, for athletic activities, medical procedures, and machinery operation. In particular, athletes may be required to remove earrings during practice or competition.

Because jewelry may be small and/or fragile, it can be easily lost or damaged when removed, in particular if there is not a designated location to temporarily store the jewelry while removed. Additionally, available locations such as purses, apparel bags, athletic gear bags, or lockers may harbor dirt or bacteria that can have a negative effect on skin should it come into contact thereto. Especially in the case of recently pierced skin, it is recommended to keep the skin as clean as possible, and the introduction of bacteria onto this area can lead to infection. As such, there is a need to provide a portable, clean storage device for jewelry.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

The subject matter herein relates to methods, systems, and devices for storing small objects, in particular jewelry. In some embodiments the subject matter herein relates to a portable storage device for jewelry and other small objects, including for example jewelry for pierced skin, and associated methods of hygienic treatment thereof.

The device according to the disclosure herein provides a solution to the difficulty of finding a small jewelry item stored haphazardly in a large area and also to keeping the jewelry clean while removed and sanitizing prior to replacing jewelry. According to a first aspect of the invention, a storage and cleaning device is described. A storage and cleaning device in accordance with this disclosure can be used to securely store any suitable item, such as for example jewelry items, particularly including earrings for ears or other pierced body parts. Because the device is portable, it can be stored in a purse or sports gear bag, for example, and the device may thus be employed at a time when it becomes necessary to remove jewelry. The jewelry can be stored in a latching portion of the device and can be optionally coated with an antibiotic ointment by the user.

Applying ointment to the jewelry helps prevent infection and aids in the reinsertion of the jewelry. Antibiotic cream or ointment can also help reduce pain associated with reinserting jewelry posts in newly pierced body parts. Additionally, upon occasion to reinsert the jewelry, the user can use another portion or component of the device to spray or otherwise apply a sanitizing fluid onto the pierced body part and/or on the jewelry in order to cleanse it prior to putting the jewelry back on. The cleansing spray provides an additional measure to remove dirt and bacteria from the skin and/or jewelry before reapplying the jewelry.

According to another aspect of the disclosure herein, adhesive stickers can be provided with the device. These may be used for identification or for customization, for example. The device is also reusable and refillable, reducing waste.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter. Preferred embodiments of the subject matter described herein will now be explained with reference to the accompanying drawings, wherein like reference numerals represent like parts, of which:

FIG. 1 is a line drawing illustrating a first exemplary embodiment of a storage and cleaning device according to the subject matter described herein;

FIG. 2 is a cross-sectional view illustrating a second exemplary embodiment of a storage and cleaning device in a disassembled state according to the subject matter described herein; and

FIG. 3 is an isometric view illustrating a second exemplary embodiment of the storage and cleaning device in an assembled state according to the subject matter described herein.

### DETAILED DESCRIPTION

The presently disclosed subject matter now will be described more fully hereinafter, in which some, but not all embodiments of the presently disclosed subject matter are described. The presently disclosed subject matter can be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the presently disclosed subject matter. While the following terms are believed to be well understood by one of ordinary skill in the art, the following definitions are set forth to facilitate explanation of the presently disclosed subject matter.

Following long-standing patent law convention, the terms “a”, “an”, and “the” refer to “one or more” when used in this application, including the claims. Thus, for example, reference to “a cell” includes a plurality of such cells, and so forth.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

The subject matter disclosed herein addresses problems encountered when removing jewelry while away from home. It is sometimes necessary to remove jewelry either expectedly or unexpectedly at a location away from the jewelry's designated storage place. Under these circumstances it is therefore necessary to temporarily store the jewelry in a suitable place.

In addition to its small size, jewelry is often fragile and/or valuable, thus making it desirable to store it in such a way that it is not easily lost or damaged. Some common locations for temporarily storing jewelry include, for example, a purse, a locker, a sports bag, or even a clothing pocket. Some drawbacks of these locations are that they are large, or unsecured, or exposed to dirt, bacteria or other contaminates. It is thus preferable to have a designated device within which to store jewelry which makes the jewelry easy to find, keeps the jewelry clean, and is sized appropriately.

In one embodiment of the disclosure herein, a storage and cleaning device is disclosed which is advantageously configured to store small items such as jewelry. The device, in some embodiments, comprises a hollow body divided into a plurality of areas, such as for example one, two, three, or more areas. At one end there is a recess with a lid, configured to contain a quantity of material such as cream or ointment. At the other end there is a main compartment to hold fluid and a dispensing mechanism, such as spray nozzle or other apparatus, for dispensing the fluid. Substantially in the middle of the hollow body there is a secondary compartment with a latchable cover configured to open and close to provide access to the secondary compartment.

In some embodiments, the secondary compartment can be a separate compartment that is removable from the hollow body. It may be retained in the hollow body by an interference snap fit, for example, although other mechanisms for securing the secondary compartment are suitable without departing from the scope of the instant disclosure. According to other embodiments, the storage compartment can be integrated into the hollow body and comprises a cover formed into the surface of the hollow body. In an exemplary embodiment, the device may be cylindrical with a length of about five inches and a diameter of about 0.75 inches. In other embodiments the device may be cylindrical with a length of about four to about six inches and a diameter of about 0.5 inches to about 1.5 inches.

The storage and cleaning device can further be used in systems and methods according to the disclosure herein. A system using the device can comprise a quantity of a material such as an antibiotic cream or gel, a quantity of antiseptic fluid such as alcohol or saltwater, and the storage and cleaning device. The device can comprise a hollow body with a main compartment, a spray nozzle disposed at a first end for dispensing the quantity of fluid retained within the main compartment, a recess and a lid disposed at a second end of the hollow body configured to contain the cream, gel or ointment material, and a secondary compartment with a latchable cover disposed within the hollow body configured to securely store one or more items, such as at least one pair of earrings. The system can be additionally supplied with one or more adhesive stickers for personalizing and/or identifying the device. The system may additionally comprise a cap for the spray nozzle and/or a mechanism to dispense the cream material.

In another embodiment a storage and cleaning system is provided that comprises a contained quantity of material, a contained quantity of liquid, and a storage and cleaning device. The storage and cleaning device of such a system can comprise a hollow body comprising three separated compartments, wherein a first compartment is configured to contain a liquid, a second compartment is configured to store one or more items, and a third compartment is configured to store a gel. The hollow body can comprise a first end and a second end, wherein the first compartment is disposed at the first end and further comprises a spray nozzle disposed at the first end of the hollow body and is configured to dispense a quantity of liquid retained within the first compartment. The third compartment is disposed at the second end and comprises a recess with a removable lid to enclose the recess. The second compartment can comprise a latchable cover.

A method of storing and cleaning a suitable item according to the disclosure is described hereinbelow. The method may be accomplished by providing a storage and cleaning device as described above and, as needed, storing suitable items such as pierced jewelry within the secondary compartment of the device. The item may be removed as desired, for example, upon occasion to replace the jewelry onto the body. The user can choose to spray the antiseptic fluid onto the pierced body part and/or the jewelry prior to replacing the jewelry. The user may additionally apply the antibiotic cream or gel onto the post of the jewelry. This provides several benefits: to create a low-friction coating for the post for ease of reinsertion, to reduce possible pain of reinsertion, and to reduce exposure of the pierced body part to bacteria. The user can also choose to personalize the storage and cleaning device with a selection of adhesive stickers which can be provided with the device.

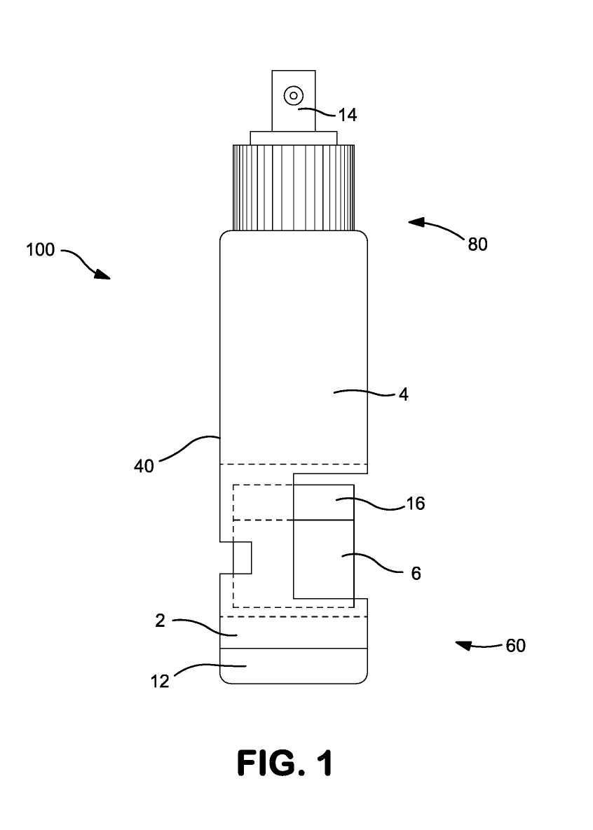

FIG. 1 is a view of an embodiment of a storage and cleaning device generally designated 100. Device 100 comprises hollow body 40 with a first end generally designated 80 and a second end generally designated 60. At first end 80 dispensing mechanism or spray nozzle 14 is provided. Spray nozzle 14 is removably connected to main compartment 4, in some embodiments by way of a threaded cap, which is configured to contain a fluid (not shown) such as saltwater solution, ear care solution, alcohol, etc. The volume of fluid can be approximately 0.5 oz. Spray nozzle 14 can be used to spray the fluid onto a pierced body part prior to reinserting jewelry. Recess 2 is disposed at second end 60 and is configured to contain a quantity of a material such as hypo-allergenic cream, gel or antibiotic ointment (not shown). The quantity of material can be approximately 0.25 oz. Recess 2 is enclosed by lid 12 which can be removed for filling and/or replacing the cream or gel. Lid 12 can in some embodiments be threadingly engaged and/or snap fitted to second end 60 to thereby allow lid 12 to be removed and resecured as needed.

Hollow body 40 additionally comprises a region for secondary compartment 6. Secondary compartment 6 can in some embodiments comprise a container configured to provide a storage area for small items such as earrings or other jewelry. Secondary compartment 6 can be configured to reside in a recess in hollow body 40 as shown in FIG. 1. In some embodiments secondary compartment 6 can be removable from hollow body 40. A cover 16 is also provided which can be secured to secondary compartment 6 in a suitable fashion such as a screw on lid or flip cap, for example.

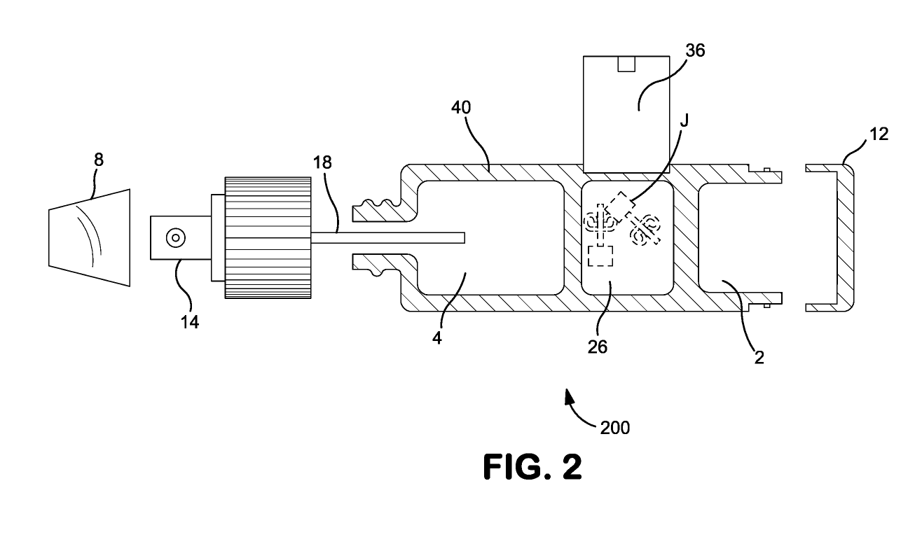

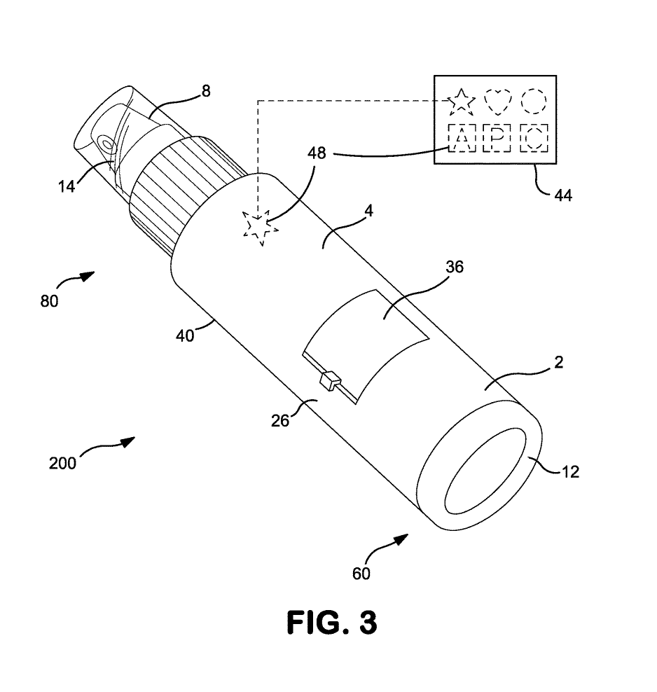

FIG. 2 shows a cross-sectional view of another embodiment of the storage and cleaning device generally designated 200. Dispensing mechanism or spray nozzle 14 can be a pump-style spray nozzle with siphon tube 18 disposed in the main compartment 4. In some embodiments main compartment 4 can hold approximately 0.25 to 1.0 fluid ounces of fluid of the types listed above. In some embodiments cap 8 can be provided to protect the spray nozzle from exposure to dirt. Device 200 can be cylindrical and preferably made of injection molded plastic material, although other suitable materials, such as metal, may be substituted. In the embodiment of FIG. 2, secondary compartment 26 can be securely closed with latchable cover 36, which can be molded into hollow body 40 and hinged along one edge. Suitable small items, such as jewelry generally designated J, can be stored within. Latchable cover 36 can further be contoured to match an external shape of hollow body 40. FIG. 2 depicts latchable cover 36 in an open state, while FIG. 3 depicts latchable cover 36 in a closed state.

FIG. 3 is a view of an embodiment of a storage and cleaning device generally designated 200. Device 200 comprises hollow body 40 with a first end generally designated 80 and a second end generally designated 60. At first end 80 dispensing mechanism or spray nozzle 14 is provided. Recess 2 is disposed at second end 60 and is configured to contain a quantity of a material such as hypo-allergenic cream, gel or antibiotic ointment (not shown). Recess 2 is enclosed by lid 12 which can be removed for filling and/or replacing the cream, gel or ointment. Lid 12 can in some embodiments be threadingly engaged and/or snap fitted to second end 60 to thereby allow lid 12 to be removed and resecured as needed.

FIG. 3 also depicts optional sticker sheet 44, comprising one or more adhesive stickers 48. Sticker sheet 44 can be provided in a system comprising device 200. The stickers can be applied to hollow body 40 to customize the appearance of device 200 and/or provide a mechanism for labelling or otherwise identifying the device.

The present subject matter presented herein can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A storage and cleaning device comprising:
a hollow body having a main compartment configured to retain a quantity of fluid;
a dispensing mechanism disposed at a first end of the hollow body and configured to dispense the fluid retained within the main compartment of the hollow body;
a secondary compartment disposed within the hollow body and configured to securely store one or more items, wherein the secondary compartment comprises a latchable cover;
a recess disposed at a second end of the hollow body and configured to contain a quantity of material; and
a removable lid configured to enclose the recess.

2. The device of claim 1, wherein the hollow body is configured as a cylindrical hollow body comprising a length of approximately five inches and a diameter of approximately 0.75 inches.

3. The device of claim 1, wherein the secondary compartment is removable from the main compartment of the hollow body.

4. The device of claim 1, wherein the latchable cover is attached at one edge to the hollow body and is contoured to match an external shape of the hollow body.

5. The device of claim 1, further comprising a cap configured to enclose the dispensing mechanism at the second end of the hollow body.

6. The device of claim 1, wherein the dispensing mechanism comprises a spray nozzle comprising a pump spray nozzle and a siphon tube disposed within the main compartment of the hollow body.

7. The device of claim 1, wherein the quantity of fluid is about 0.5 to about 1.0 fluid ounces.

8. The device of claim 1, wherein the device comprises an injection molded plastic material.

9. A storage and cleaning system comprising:
a contained quantity of material;
a contained quantity of liquid; and
a storage and cleaning device comprising a hollow body comprising three separated compartments, wherein a first compartment is configured to contain a liquid, a second compartment is configured to store one or more items, and a third compartment is configured to store a gel;
wherein the hollow body comprises a first end and a second end;
wherein the first compartment is disposed at the first end and further comprises a spray nozzle disposed at the first end of the hollow body and is configured to dispense a quantity of liquid retained within the first compartment;
wherein the third compartment is disposed at the second end and comprises a recess with a removable lid to enclose the recess; and
wherein the second compartment comprises a latchable cover.

10. The system of claim 9, further comprising one or more adhesive stickers for personalizing the device.

11. The system of claim 9, wherein the device comprises a cap configured to cover the spray nozzle.

12. The system of claim 9, wherein the device comprises an injection molded plastic material.

13. The system of claim 9, wherein the hollow body of the device is configured as a cylindrical hollow body comprising a length of approximately five inches and a diameter of approximately 0.75 inches, and wherein the quantity of liquid is approximately 0.5 fluid ounces.

14. A method for storing and cleaning one or more items, the method comprising:
providing a storage and cleaning device, comprising:
a hollow body having a main compartment configured to retain a quantity of fluid;
a dispensing mechanism disposed at a first end of the hollow body and configured to dispense the fluid;
a secondary compartment disposed within the hollow body and configured to securely store one or more items within;
a recess disposed at a second end of the hollow body and configured to contain a quantity of material;
a removable lid configured to enclose the recess; and
storing the one or more items within the secondary compartment.

15. The method of claim 14, further comprising dispensing at least a portion of the quantity of fluid retained within the main compartment of the hollow body on a body part.

16. The method of claim 14, further comprising applying at least a portion of the quantity of material contained within the recess onto the one or more items.

17. The method of claim 14, further comprising applying one or more adhesive stickers onto the hollow body for personalizing the storage and cleaning device.
